(19) United States
(12) Patent Application Publication
(10) Pub. No.: US 2023/0329959 A1
(43) Pub. Date: Oct. 19, 2023

(54) MASSAGE THERAPY DEVICE AND METHOD

(71) Applicant: Pamela Denise McDaniel, Castro Valley, CA (US)

(72) Inventor: Pamela Denise McDaniel, Castro Valley, CA (US)

(21) Appl. No.: 18/299,783

(22) Filed: Apr. 13, 2023

Related U.S. Application Data
(60) Provisional application No. 63/330,454, filed on Apr. 13, 2022.

(51) Int. Cl. A61H 15/00

(52) U.S. Cl. CPC A61H 15/00; A61H 2201/1284; A61H 2201/0153; A61H 2203/0406; A61H 2203/0431; A61H 2201/0221; A61H 2205/125; A61H 2201/1654; A61H 2201/0214; A61H 2203/0443; A61H 2201/0207; A61H 2201/0192; A61H 2203/0437; A61H 2015/0064

(57) ABSTRACT

The present disclosure relates to a device that is used in conjunction with different types of massage implements that can be used to massage the user. The massage therapy device and method is a pouch with a hollow interior for holding the massage implement such as mobility ball. A strap is coupled to the pouch and utilized to maintain a position of the massage implement relative to the user when the massage therapy device is in use. The massage therapy device and method prevents various size mobility balls from slipping while trying to target specific areas of the body. The strap, located on each side of the pouch, includes an adjustable loop to facilitate the used grasping the strap and adjusting a length of the strap.

### CROSS-REFERENCE TO RELATED APPLICATIONS

This application claims the benefit of U.S. Provisional Application No. 63/330,454, filed on Apr. 13, 2022. The entire disclosure of the above application is incorporated herein by reference.

### FIELD

The present invention relates to a massage device, and more particularly, a device configured to work with massage implements.

### INTRODUCTION

This section provides background information related to the present disclosure which is not necessarily prior art.

Massage is one of the oldest forms of preventative medical care and has evolved to encompass different forms of therapy and exercise, like yoga. Massage is now used in intensive care units and even used recreationally for all age groups. Massage can be used to treat a variety of ailments ranging from arthritis to strokes, muscle recovery, inflexibility, and can be used to improve mobility.

There are a number of massage implements which have been developed to assist in massage therapy and exercise. One of the most common massage implements is a mobility ball. Mobility balls are oftentimes configured to apply pressure points and come in a range of sizes, densities, and firmness. While there are many mobility balls on the market, there still exists a need for a device that can allow mobility balls to rotate while keeping them from rolling away, in use.

Oftentimes, doctors recommend filling and freezing a water bottle and rolling it along the bottom of a patient's foot to relieve pain associated with plantar fasciitis. However, the water bottle will oftentimes accrue condensation on the outside of the water bottle due to the temperature difference between the frozen water bottle and the water vapor present in the air. This may create unsafe conditions as the water bottle gets slippery from the condensation coating the bottle.

Accordingly, there is a need for a massage therapy device that can stabilize massage implements and products like mobility balls and frozen water bottles used to pinpoint and massage all major muscle groups. Furthermore, there is a need for a massage therapy device which is relatively simple in construction, durable, and inexpensive to manufacture.

### SUMMARY

In concordance with the instant disclosure, a massage therapy device that improves the quality of massages, and which can function as a yoga tool, has been surprisingly discovered.

In one embodiment, a massage therapy device for a person to use with a massage implement is disclosed. The massage therapy device includes a pouch having a hollow interior and an opening configured to allow the massage implement to be received in the hollow interior of the pouch. A strap is coupled to the pouch and configured to maintain a position of the massage implement relative to the person when the massage therapy device is in use and when the massage implement is received in the hollow interior of the pouch.

In another embodiment, a massage therapy device for a person to use with a massage implement includes a pouch having a hollow interior and an opening configured to allow the massage implement to be received in the hollow interior of the pouch. A fastening means is disposed adjacent the opening and configured to selectively retain the opening in a closed position to secure the massage implement in the hollow interior of the pouch. Coupled to the pouch is a strap is that includes a first free end, a second free end, a first slidable fastener, and a second slidable fastener, wherein the strap is configured to maintain a position of the massage implement relative to the person when the massage therapy device is in use and when the massage implement is received in the hollow interior of the pouch. The strap can include a first handle formed by looping the first free end of the strap and securing the first free end to the strap with the first slidable fastener to create a first loop, and a second handle formed by looping the second free end of the strap and securing the second free end to the strap with the second slidable fastener to create a second loop.

In yet another embodiment, a method of using a massage therapy device on a target body area of a person is disclosed. The method includes providing a massage therapy device having a pouch with a hollow interior and an opening configured to allow the massage implement to be received in the hollow interior of the pouch and a strap coupled to the pouch. A massage implement is placed through the opening into the hollow interior of the pouch. The massage implement received in the hollow interior of the pouch is disposed against the target body area of the person and maintained against the target body area of the person.

The massage therapy device having the pouch and strap can be adapted to be used in accordance with massaging all major muscle groups with an emphasis on massaging the feet. The pouch allows existing mobility balls to roll freely within the pouch and is attached to a strap which allows the user to easily adjust the angle and pressure of the mobility balls. The pouch can also hold objects that can be used for massages widely used for massages such as a frozen water bottle, or objects which can be heated, like hand-warmers. The massage therapy device is compatible with a variety of mobility balls, frozen water bottles, and heated balls already on the market. In addition, there is a need for a massage therapy device that can be easily adjusted to pinpoint and massage all major muscle groups.

Embodiments of the massage therapy device can include a pouch with a strap, including a pouch with receiving means having a main body with a first end and a second end. In some embodiments, an opening with fastening means can be disposed between the first and second end. Embodiments can also include at least one holding means disposed on each of the first end and second end of the main body.

In some embodiments, the pouch with the receiving means, the opening with fastening means, and each holding means disposed on each of the first and second end can be configured together to receive a mobility ball within the receiving means and secured by the fastening means to hold the mobility ball within the pouch. In some embodiments, the holding means allow the user to adjust the placement of the mobility ball. In some embodiments, the massage therapy device of can have a pouch with a main body with an opening and a hollow interior which is configured to accept and retain the massage body. The message therapy device can have two straps or a single strap which is threaded through the main body of the pouch. The entry point for the strap can removably fastened or left open to allow the user to selectively insert and remove one or more massage bodies. In some embodiments, the fastening means include hook and loop fasteners, a zipper, hooks, buttons, and other fastening means.

Different embodiments of the pouch can be constructed from one or more of the following materials: water resistant material, waterproof material, stretchable material such as spandex or nylon, puncture resistant material, heat resistant material, tear resistant material, and materials that are washable. The pouch can have a strap that is made from a webbing material which have a slider, buckle, or clip to form a loop which can act as a handle. One side of the pouch can have an opening with fastening means located on the top and bottom of the opening such as hook and loop fasteners, buttons, zippers, and a combination thereof. The opening can allow a user to insert at least one mobility ball of varying size, a frozen water bottle, a variety of other objects that can be used for physical therapy or massages, and combinations thereof. This allows the user to use this device in conjunction with mobility balls the user can already own. Certain embodiments of the pouch can have a length between about 8 inches to about 10 inches and a width between about 4 inches to about 6 inches. Other embodiments of the pouch can be significantly smaller with a diameter between about 1.7 inches to about 3 inches.

The massage therapy device and method can be used to massage all areas of the body. Further, the present disclosure includes a method of using the strap to perform yoga stretches. Embodiments of the present disclosure can also include a pouch and a strap, where the pouch includes a first end and a second end. In some embodiments, an opening can be disposed between the first and second end. In certain embodiments a single strap can be threaded through a pouch with only two (2) holes and one of the holes can be used to insert the mobility ball or object.

Some embodiments can allow the user to fit more than one mobility ball or object into the pouch. Embodiments can also include two straps attached respectively to the pouch's first end and second end. Embodiments can also include a loop on each strap at the end furthest from the pouch. In some embodiments, the straps can be made of a webbed material like nylon.

Embodiments of using a massage therapy device can include the steps of placing a massage device into the pouch, positioning the pouch between the target area and a support surface, placing the user's limbs into the straps and stabilizing the pouch while exerting force against the massage device and the support surface. Another method of using the pouch includes taking similar steps without using a support surface and applying force to the straps to massage target areas of the body. The method can also be performed while the user is sitting, reclined, or lying down.

The user can use the massage therapy device and method to position a mobility ball, held within the pouch, on a specific part of the body while the user applies pressure to the target area by pulling the straps or using the straps to stabilize the mobility ball whilst applying force against the mobility ball by leaning, stepping, or rolling. More particularly, the massage therapy device and method can be used to position a mobility ball underneath the foot without the mobility ball slipping underneath the foot. The adjustable straps allow a user to control the amount of pressure that is applied to relieve physical ailments typically treated with massages such as foot pain.

The massage therapy device allows one or more massage bodies and other objects to be freely moved without losing control of the item. This is particularly useful for users who struggle with flexibility and reaching down to adjust or retrieve items from the floor, such as older individuals. Further, this device allows the user to apply pressure selectively by pulling against the straps. The straps are adjustable, allowing each loop cord to be lengthened or shortened to increase ease of use. To that effect, device can be used while sitting or lying, permitting those with who experience discomfort while standing to adjust the force applied on specific areas.

Other massage tools do not manually allow a user to have complete directional control of movements of a mobility ball or allow a second usage by stretching other extremities such as a user's calves, arms, back, and legs. A user can control the movements of a mobility ball or other object, control the amount of applied pressure for the mobility ball, and stretch other extremities. The massage therapy device and method helps relieve foot and heel pain associated with plantar fasciitis, heel spurs, and tired feet, by relaxing muscles. The massage therapy device and method can be used for physical therapy treatment and recovery from injuries to improve range of motion, flexibility, and strength.

Further areas of applicability will become apparent from the description provided herein. It should be understood that the description and specific examples are intended for purposes of illustration only and are not intended to limit the scope of the present disclosure.

### DRAWINGS

The drawing described herein for illustration purposes only and not intended to limit the scope of the present disclosure in any way.

FIG. 1 is a top perspective view of an embodiment of a massage therapy device including a pouch, a strap, and a mobility ball.

FIG. 2 is a fragmentary bottom perspective view of the massage therapy device shown in FIG. 1.

FIG. 3 is a fragmentary bottom perspective view showing another embodiment of the massage therapy device shown in FIG. 1.

FIG. 4 depicts inset A of FIG. 1 showing an embodiment of a fastening means for the pouch of the massage therapy device.

FIG. 5 depicts inset A of FIG. 1 showing another embodiment of the fastening means for the pouch of the massage therapy device.

FIG. 6 depicts an embodiment of the massage therapy device in use.

FIG. 7 depicts a flowchart of an embodiment of a method of using the massage therapy device.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. It should be understood that throughout the drawings, corresponding reference numerals indicate like or corresponding parts and features.

Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIGS. is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

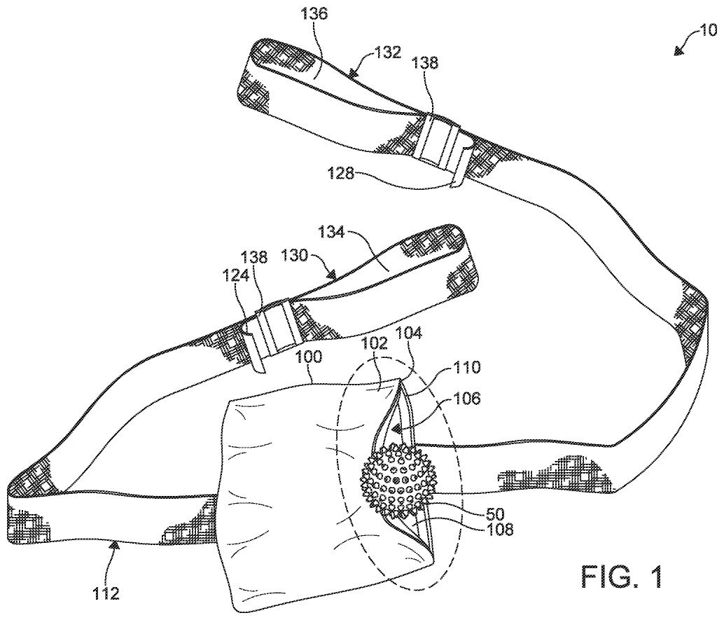

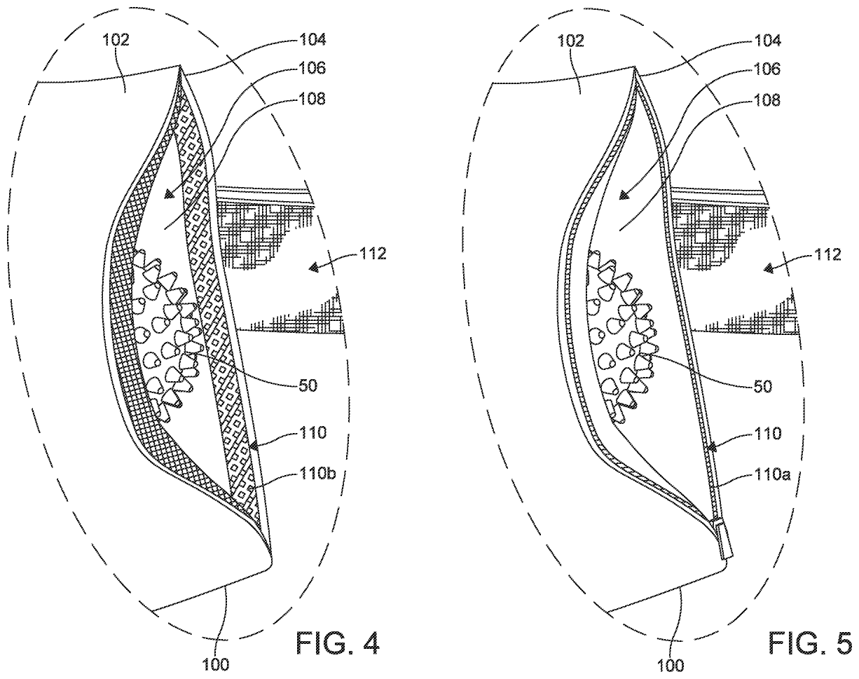

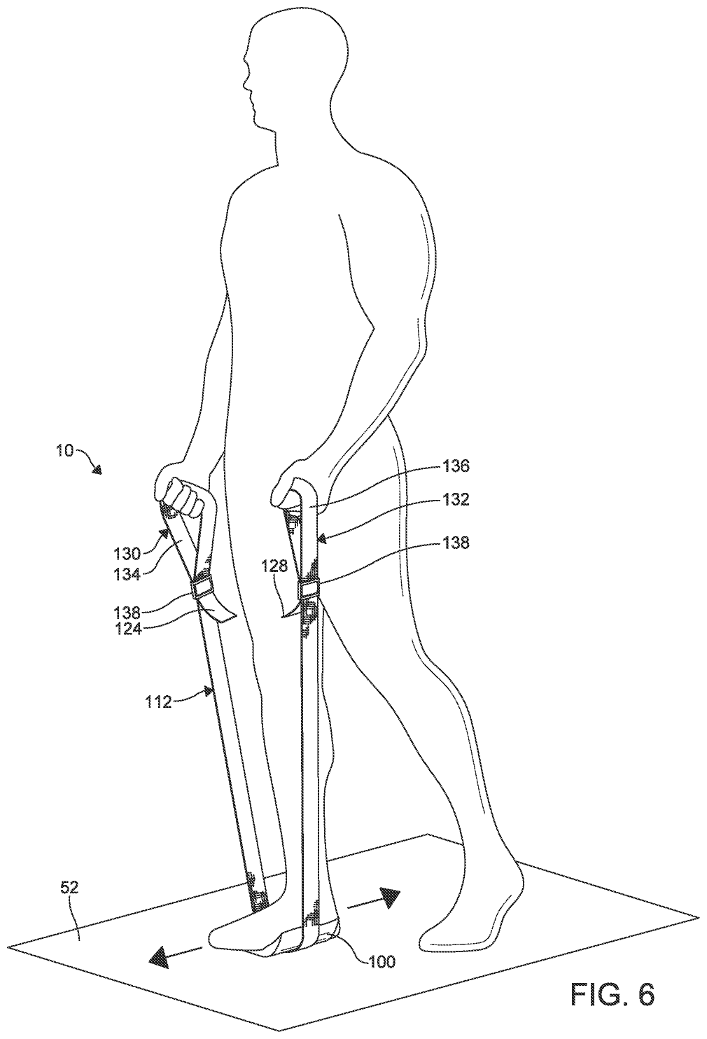

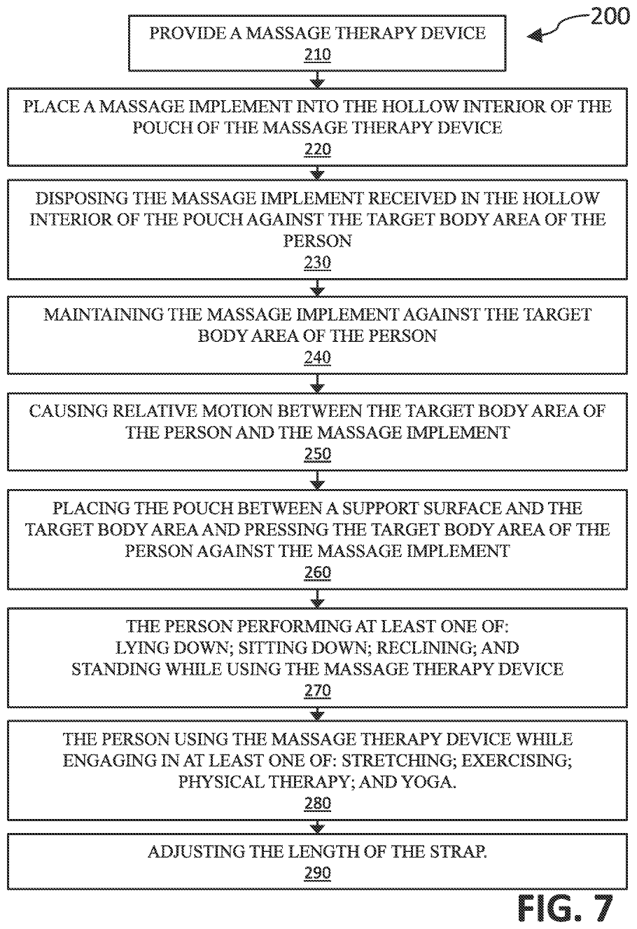

With reference to the FIGS. 1-7, a massage therapy device 10 can be employed by a user alone or assisted by one or more additional persons to massage all major muscle groups with an emphasis on massaging the feet. Furthermore, the massage therapy device 10 can be used as an exercise device and, in particular, as a yoga tool to facilitate engaging in selected yoga stretches, positions, and movements.

The massage therapy device 10 includes a pouch 100 having a first side 102 and a second side 104, wherein the two sides 102, 104 are joined together adjacent the periphery to form a hollow interior 106 therebetween. The first side 102 and the second side 104 are made from a flexible material such as a woven fabric, a webbing material, or a sheet material, wherein synthetic or natural fibers and sheet material can be used as desired. Furthermore, the flexible material can include at least one of the properties of being washable, water resistant, waterproof, moisture absorbing, heat resistant, thermally insulating, tear resistant, stretchable (such as spandex or nylon), puncture resistant material, and inelastic.

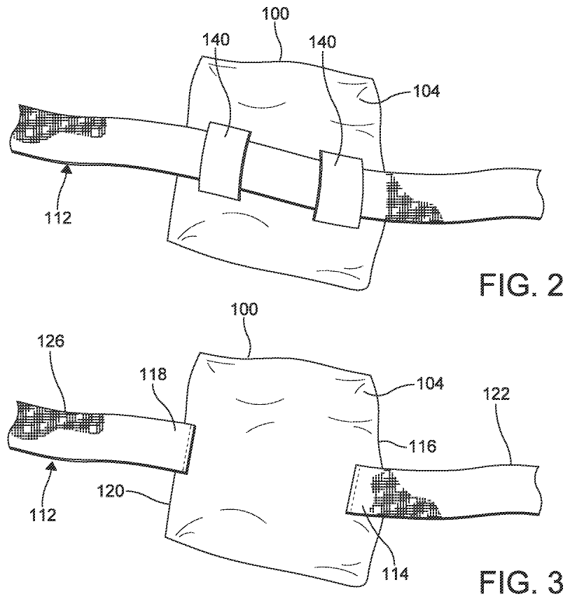

An opening 108 is formed in the pouch 100 that provides access to the hollow interior 106. The opening 108 can be formed in one of the first side 102 and the second side 104 of the pouch 100. Alternatively, the opening 108 can be formed at the peripheral edge of the pouch 100 between the first side 102 and the second side 104. A fastening means 110 is disposed adjacent the opening 108 that is configured to selectively open and close the opening 108. It should be understood that the fastening means 110 can include a zipper 110a, as shown in FIG. 3, a hook and loop fastener 110b, as shown in FIG. 2, or other fastening means, such as a draw string, a snap, and/or a button and buttonhole, for example.

The hollow interior 106 and the opening 108 are configured to receive a massage implement 50 and enable the massage implement 50 to move and/or rotate within the hollow interior 106 as well as move and/or rotate with respect to the user and a support surface 52, such as a floor, wall, or exercise device, for example. In the illustrated embodiment, the massage implement 50 is a mobility ball commonly known in the practice of massage therapy as massage balls, myofascial release balls, and physical therapy balls. It should be understood that other types of massage implements 50 can also be used, such as massage rollers and water bottles, for example. It should also be understood that more than one massage implement 50 can be placed in the hollow interior 106 of the pouch 100 and that the massage implement 50 can be heated, cooled, and frozen prior to placing it in the pouch 100. Upon placing the massage implement through the opening 108 into the hollow interior 106 of the pouch 100, the opening can be closed utilizing the fastening means 110 in order to retain the massage implement 50 within the hollow interior 106 of the pouch 100 during the use of the massage therapy device 10.

In the illustrated embodiment, the pouch 100 is shown having a substantially square cross-section or profile. However, it should be understood that the pouch can have other cross-sectional shapes, such as rectangles, circles, triangles, and other geometric shapes, as desired. Furthermore, the shape of the pouch 100 can be selected based on a shape of specific massage implements 50 to facilitate placing the massage implement 50 into the hollow interior 106 of the pouch 100, or based on a desired movement of the massage implement 50 within the pouch or with respect to the user or the support surface 52. In certain embodiments, the pouch 100 can have a length between about 8 inches to about 10 inches and a width between about 4 inches to about 6 inches. In other embodiments, the pouch can be circular in shape and have a diameter between about 1.7 inches to about 3 inches. In yet other embodiments, the pouch 100 can be smaller or larger than these dimensions.

A strap 112 is coupled to the pouch 100 and is configured to allow the user to easily adjust the location, position, and the angle of the pouch 100 and the massage implement 50 with respect to the user's body. With reference to FIG. 2, the strap 112 can be movably coupled to the pouch 100 utilizing loop fasteners 140 formed in or coupled to the pouch 100. It should be understood that other ways can be used to movably couple the strap 112 to the pouch 100, such as a sleeve formed in or disposed on the pouch 100, where the sleeve spans a majority or even an entirety of the pouch 100. The strap 112 can be fixedly coupled to the pouch 100 by sewing, riveting, using an adhesive, or other means effective to fixedly couple the strap 112 to the pouch 100. It should be understood that a length of the strap 112 can be adjustable to facilitate users of different size, use of the massage therapy device 10 while in various positions (e.g., standing, sitting, reclining, laying), and placing the pouch 100 at different target body areas of the user.

The strap 112 can include a first free end 124 and a second free end 128. The user can grip the first and second free ends 124, 128 of the strap 112. Once gripped, the strap 112 enables the user to position the pouch 100 on a target body area of the user and then apply a massaging force to the target area. Furthermore, when employed as an exercise device and/or a yoga tool, the strap 112 enables the user to position the pouch 100 as desired to apply a stretching force to facilitate stretching and engaging in selected yoga stretches, positions, and movements. Furthermore, the strap 112 enables the user to stabilize and adjust a location and a position of the pouch 100 and the massage implement 50 with respect to the target body area of the user.

The strap 112 can include a first handle 130 and a second handle 132, wherein the handles 130, 132 facilitate the user grasping and pulling the strap 112. The handles 130, 132 can be located at and/or disposed adjacent the respective free ends 124, 128 of the strap 112. In the illustrated embodiment, the first handle 130 is formed by looping the first free end 124 of the strap 112 and fastening the first free end 124 to the strap 112 to create a first loop 134. The second handle 132 is formed by looping the second free end 128 of the strap 112 and fastening the second free end 128 to the strap 112 to create a second loop 136. In the illustrated embodiment, the free ends 124, 128 are slidably or moveable attached to the strap 112 utilizing a slidable fastener 138, such as a buckle or a clip. The slidable fastener 138 is utilized by the user to adjust the size of the loops 134, 136 and, in turn, an effective length of the strap 112. It should be understood that the loops 134, 136 can be formed in the straps 122, 126 utilizing other fastening means, and combinations thereof, such as snaps, hooks, clasps, hook and loop fasters, buttons and buttonholes, and the like, for example. It should also be understood that the handles 130, 132 can be a hand grip or the like disposed adjacent the free ends 124, 128 of the strap 112, 126. Furthermore, it should be understood that the length of the strap 112 and the can be adjusted utilizing other means such as is commonly known and used with adjustable straps for back packs, purses, satchels, computer bags, duffle bags, garment bags, and the like.

The strap 112 can be made from a flexible material such as a woven fabric, a webbing material, or a sheet material, wherein synthetic or natural fibers and sheet material can be used as desired. Furthermore, the flexible material can include at least one of the properties of being washable, water resistant, waterproof, moisture absorbing, heat resistant, thermally insulating, tear resistant, stretchable (such as rubber, spandex, or nylon), puncture resistant material, and inelastic.

In the embodiment shown in FIG. 3, the strap 112 includes a first strap 122 and a second strap 126. The first strap 122 includes a first attached end 114 and the first free end 124, wherein the first attached end 114 is coupled adjacent to a first end 116 of the pouch 100. The second strap 126 includes a second attached end 118 and the second free end 128, wherein the second attached end 118 is coupled adjacent to a second end 120 of the pouch 100. The straps 122, 126 are coupled to the pouch 100 in a manner such that when a pulling force or a tension is applied to the straps 122, 126, the pouch 100 is placed in tension, wherein the tension is employed to help create the massaging force and/or the stretching force. It should be understood that at least one of the attached ends 114, 118 of the straps 122, 126 can be fixedly coupled to the pouch 100 by sewing, riveting, using an adhesive, or other means effective to couple the strap 112 to the pouch 100. Additionally, it should be understood that at least one of the attached ends 114, 118 of the straps 122, 126 can be moveably or adjustably coupled to the pouch 100. For example, an opening through the pouch 100 can be provided and one of the attached ends 114, 118 can be threaded through the opening and slidable or moveably attached to the respective strap 122, 126. The attached ends 114, 118 can be joined to the respective strap 122, 126 utilizing a buckle, a clip, hooks, snaps, clasps, hook and loop fasters, buttons and buttonholes, and the like, for example, wherein the respective attached end 114, 118 can be moved and secured along the length of the respective strap 122, 126 to adjust the effective length of the respective strap 122, 126.

With reference to FIG. 5, a method 200 of using the massage therapy device 10 is shown. The method 200 can include a step 210 of providing the massage therapy device 10, a step 220 of placing the massage implement 50 into the pouch 100 of the massage therapy device 10, a step 230 of positioning the pouch 100 against a target area of the user, and a step 240 of applying a tension to the strap 112 of the massage therapy device to create a massaging force on the target area. The method 200 can include a step 250 of causing a relative motion between the target body area of the user and the massage implement to massage the target body area. The method 200 can also include a step 260 of placing the pouch 100 between the support surface 52 and the target area and the user pressing the target area against the pouch 100. The method 200 can also include a step 270 of the user lying down, sitting down, reclining, or standing up while using the massage therapy device 10 to massage, stretch or exercise the target area. A step 280 of the method 200 can include engaging in stretching, exercising, physical therapy, and/or yoga utilizing the massage therapy device 10.

The massage therapy device 10 allows one or more massage implements 50 to be freely moved without losing control of them. This is particularly useful for users who struggle with flexibility and reaching down to adjust or retrieve items from the floor, such as older individuals. Further, this massage therapy device 10 allows the user to apply pressure selectively by pulling against the strap 112. Furthermore, the first strap 122 and the second strap 126 are adjustable, allowing the first loop 134 and the second loop 136 cord to be lengthened or shortened to increase ease of use. To that effect, the massage therapy device 10 can be used while sitting or lying, permitting those with who experience discomfort while standing to utilize the massage therapy device 10 and adjust the force applied on the target area.

The massage therapy device 10 is light weight, easy to carry, and can be used in a variety of settings. The versatility of the massage therapy device 10 lies in part in allowing the user to utilize objects that the user may already own for the massage implement 50 such as a frozen water bottle, and a variety of other objects that can be used for physical therapy or massages to effectively target painful pressure points in any direction on the user's body.

Other massage tools do not manually allow a user to have complete directional control of movements of the massage implement or allow a second usage by stretching other extremities such as a user's calves, arms, back, and legs. A user can control the movements of the massage implement 50, control the amount of applied pressure to the massage implement 50, and stretch other extremities. The massage therapy device 10 and method 200 helps relieve foot and heel pain associated with plantar fasciitis, heel spurs, and tired feet, by relaxing muscles. The massage therapy device 10 and method 200 can be used for physical therapy treatment and recovery from injuries to improve range of motion, flexibility, and strength.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A massage therapy device for a person to use with a massage implement, the massage therapy device comprising:
a pouch having a hollow interior and an opening configured to allow the massage implement to be received in the hollow interior of the pouch; and
a strap coupled to the pouch, the strap configured to maintain a position of the massage implement relative to the person when the massage therapy device is in use and when the massage implement is received in the hollow interior of the pouch.

2. The massage therapy device of claim 1, further comprising a fastening means disposed adjacent the opening and configured to selectively retain the opening in a closed position to secure the massage implement in the hollow interior of the pouch.

3. The massage therapy device of claim 2, wherein the fastening means includes one of a hook and loop fastener and a zipper.

4. The massage therapy device of claim 1, wherein the pouch includes a water resistant or a waterproof material.

5. The massage therapy device of claim 1, wherein the pouch includes a heat resistant material.

6. The massage therapy device of claim 1, wherein the pouch includes a tear resistant material.

7. The massage therapy device of claim 1, wherein at least one of the pouch and the strap includes an adjustable coupler to movably couple the strap to the pouch.

8. The massage therapy device of claim 1, wherein the strap includes a first handle adjacent a first free end of the strap and a second handle located adjacent a second free end of the strap.

9. The massage therapy device of claim 8, wherein:
the first handle is formed by looping the first free end of the strap and fastening the first free end to the strap to create a first loop; and
the second handle is formed by looping the second free end of the strap and fastening the second free end to the strap to create a second loop.

10. The massage therapy device of claim 9, wherein the strap includes:
a first slidable fastener configured to cooperate with the first free end of the strap to form and adjust a size of the first loop; and
a second slidable fastener configured to cooperate with the second free end of the strap to form and adjust a size of the second loop.

11. The massage therapy device of claim 10, wherein the first slidable fastener and the second slidable fastener are one of a clip and a buckle.

12. The massage therapy device of claim 8, wherein the strap includes:
a first strap having a first attached end and the first free end, the first attached end of the first strap coupled to a first end of the pouch, and
a second strap having a second attached end and the second free end, and the second attached end of the second strap coupled to a second end of the pouch.

13. A massage therapy kit for a person to apply a massaging force to their body, comprising:
a massage implement; and
the massage therapy device according to claim 1.

14. A massage therapy device for a person to use with a massage implement, the massage therapy device comprising:
a pouch having a hollow interior and an opening configured to allow the massage implement to be received in the hollow interior of the pouch;
a fastening means disposed adjacent the opening and configured to selectively retain the opening in a closed position to secure the massage implement in the hollow interior of the pouch; and
a strap coupled to the pouch and including a first free end, a second free end, a first slidable fastener, and a second slidable fastener, the strap configured to maintain a position of the massage implement relative to the person when the massage therapy device is in use and when the massage implement is received in the hollow interior of the pouch, the strap having:
a first handle formed by looping the first free end of the strap and securing the first free end to the strap with the first slidable fastener to create a first loop, and
a second handle formed by looping the second free end of the strap and securing the second free end to the strap with the second slidable fastener to create a second loop.

15. A method of using a massage therapy device on a target body area of a person, the method comprising:
providing a massage therapy device, the massage therapy device including
a pouch having a hollow interior and an opening configured to allow a massage implement to be received in the hollow interior of the pouch, and
a strap coupled to the pouch;
placing the massage implement through the opening into the hollow interior of the pouch;
disposing the massage implement received in the hollow interior of the pouch against the target body area of the person; and
maintaining the massage implement against the target body area of the person.

16. The method of claim 15, further comprising causing relative motion between the target body area of the person and the massage implement placed in the hollow interior of the pouch.

17. The method of claim 15, further comprising:
placing the pouch between a support surface and the target body area; and
pressing the target body area of the person against the massage implement placed in the hollow interior of the pouch.

18. The method of claim 15, further comprising the person performing at least one of:
lying down;
sitting down;
reclining; and
standing while using the massage therapy device on the target body area.

19. The method of claim 15, wherein the massage therapy device is used to facilitate the person engaging in at least one of:
stretching;
exercising;
physical therapy; and
yoga.

20. The method of claim 15, wherein a length of the strap can be adjusted, and the person adjusts the length of the strap to facilitate maintaining the massage implement against the target body area.
